(19) United States
(12) Patent Application Publication
(10) Pub. No.: US 2003/0216930 A1
(43) Pub. Date: Nov. 20, 2003

(54) Cost-per-action search engine system, method and apparatus

(76) Inventors: Carl A. Dunham, Westlake Village, CA (US); Alan Trzcinko, Westlake Village, CA (US); Brian D. McCarthy, Westlake Village, CA (US); James K. Beriker, West Village, CA (US)

Correspondence Address: Brull Piccionelli Sarno Braun & Vradenburgh, Suite 2350, 1925 Century Park East, Los Angeles, CA, 90067, US

(21) Appl. No.: 10/210,677

(22) Filed: Jul. 31, 2002

Related U.S. Application Data
(60) Provisional application No. 60/381,211, filed on May 16, 2002.

(51) Int. Cl. G06F 17/60

(52) U.S. Cl. 705/1; 705/14

(57) ABSTRACT

Embodiments of the present invention are directed to a search engine system, method and apparatus comprising a search engine, a participant management system, at least one storage database, a listing database and at least one feedback mechanism. The search engine accepts input data and utilizes the input data to search for information related to the search terms. Upon retrieval of relevant information, the data analysis module organizes the data related to the search terms into a search results list. To determine the placement of listings upon a search request, the data analysis module determines the probability, for each relevant listing, that the user will ultimately complete the desired action if the listing is shown, wherein the probability of action is determined by a plurality of factors. This probability is then combined with the specific CPA for the advertiser. Transaction information derived from a search and click is returned through the feedback mechanism to the search engine for revised calculation of listing placement.

### RELATED APPLICATION

This application is related to, and claims priority from, U.S. Patent Application, entitled A Cost-Per-Action Search Engine System, Method and Apparatus, Serial No. 60/381,211 filed May 16, 2002, and is fully incorporated herein by reference.

### FIELD OF THE INVENTION

The present invention is directed to a system, method and apparatus for a cost-per-action search engine. More specifically, embodiments of the invention are directed to a search engine that allows advertisers to list their sites and receive keyword-driven search traffic. The invention dynamically determines the optimal placement within the search result list for each advertiser, wherein each advertiser's position within the search result list is determined by a multiplicity of variables, including the advertiser's historic success in generating actions.

### BACKGROUND OF THE INVENTION

Global computer networks, such as the World Wide Web (the “Web”) or the Internet, have become vast global marketplaces in which millions of Web sites and information providers exist on these networks at any given time. Due to the vast number of information providers that coexist on the Internet, including merchants attempting to sell products or services, advertising in a traditional manner on global computer networks results in minimal benefit. Indeed, the extensive nature of the Internet allows virtually any advertiser, on any continent, to globally promote their products and services. Due to the sheer number of advertisers and available information, and the number of Web pages published on the Web, simple advertisements may not be seen or ever encountered by a user. Thus, even if an advertiser has information, or a product or service desired by a user, users may never encounter the advertiser.

To assist users in obtaining information on the Internet, search engines have been developed. In most cases, search engines collect Web page listings by scouring the Web, using intelligent agents, spiders, bots, or other means of assessing the content of Web pages, and/or categorizing Web pages into particular content directories. Search engines allow users to enter search terms, commonly referred to as “keywords”, that relate to products, services or information desired by the user. The search engine locates Web pages within its database that it has determined to be relevant to the search terms, and presents a list of search results to the user. The listings are ranked by some factor that determines the relative relevancy of each Web site listing. In some instances, this ranking is based upon the frequency and/or density of the search terms and the placement of the search terms within the Web pages. In other instances, the determination of relevancy is based upon the number of other sites that directly or indirectly link to the Web site in question, or the popularity of the Web site as determined by the number of visitors over a specific period of time. Some engines also factor in other variables that can be measured directly, such as the relative number of times that searchers click on a particular listing. While these techniques assist in locating Web sites containing content that is relevant to the search terms entered by the user, search engine systems that are algorithmically based, as generally described above, do not always produce the most relevant search results since the system has critical inefficiencies (particularly as the number of Web pages increases more quickly than they can be categorized) and is otherwise open to “optimization”, abuse and manipulation by knowledgeable Webmasters. For example, in the case of relevancy being determined by the frequency of particular search terms appearing within the site, some creative advertisers have simply included popular search terms into their Web site, either directly as text on the Web page or in the hypertext markup language (“HTML”) and its meta tags, thereby artificially manipulating these algorithm-based search engines. An entire industry has emerged that focuses on “optimizing” placement on algorithm-based search engines.

As this process of securing placement on search engines in order to generate site “traffic” became increasingly difficult (as search engines adapted their algorithms to offset this abuse and “optimization”) paid search engines emerged, offering placement in search results based upon payment. In this model, commonly referred to as “pay-per-click” (“PPC”) or “pay for performance”, advertisers bid on search terms that are relevant to their site offering and agree to pay the search engine the bid amount every time a user clicks on the advertiser's listing, that is, the advertiser's site title and site description which are linkable to the advertiser's Uniform Resource Locator (the “URL”). Based on this system, advertisers wishing to attract users may directly control the search results by simply paying to be included. The essence of this model is that the higher the bid amount on a particular search term, the higher the placement of the advertiser's listing in the search results list for that search term. This model operates as a constant auction in which advertisers bid against each other by keyword, for higher placement on search result pages. Most PPC search engines also offer tools and reports to assist advertisers in managing their accounts.

Most PPC search engines receive users, searching by keyword, from distribution partners. Such distribution partners may include other PPC search engines, traditional search engines (such as those described above), Internet Service Providers, Web portals and other Web sites. Results for searches originating from the distribution partner are either displayed on a search results Web page hosted by the PPC search engine or within the distribution partner's own site. Search functionality is a service provided by distribution partners to their users as well as a source of revenue. As compensation for supplying searches to the PPC search engine, the distribution partner receives a form of payment which may include a flat fee per search or per click, or a share of the click revenue derived by the PPC search engine.

Although the PPC search engine model provides some economic and other benefits to advertisers, distribution partners and searchers, the model is based upon a series of assumptions that limit the effectiveness of this model, namely: (1) that advertisers are able to identify, monitor and modify search terms that best relate to their site offering; (2) that the search terms chosen by the advertiser are likely to be used by those searching for products and services on the Internet; (3) that these keyword-based searches will lead to sales, thereby resulting in a positive return-on-investment (the “ROI”), a measure of the cost of the marketing campaign against the financial results achieved by the marketing campaign; and (4) that the higher the placement in the search results list, the greater the benefits to the advertiser. The fourth assumption is the key presumption in the auction-based system.

Given the real-time dynamics of the search engine environment, and the linguistic nuances inherent in keyword-based searching, it is virtually impossible for advertisers to effectively and efficiently manage their keyword bids in a manner that optimizes ROI. There are simply too many variables outside the control of the advertiser and a general lack of feedback from the PPC search engine. Even if search terms are chosen appropriately and the account is managed optimally, advertisers have no guarantee that any users will visit their sites or that if they do visit that they will purchase any products or services. Thus, the advertisers may pay for the traffic, that is, the clicks, but not necessarily receive any benefit in terms of desired actions by the users. In this regard, the advertising campaign can cost the advertiser more money than is being generated from the campaign. As used throughout the disclosure, an “action” is an event desired by an advertiser (e.g., a sale of a product or service; the submission of an email address, the completion of an application form, a request for quote or further information, visits to specific advertiser pages and the like).

While higher listings do, in general, generate more clicks, this does not necessarily correlate to higher ROI for the advertiser. Due to the auction model, the advertiser may be forced to pay more to be in the top position than is derived from the actions of the users once they click-through to the advertiser's site. That is, the “action rate” (the ratio of actions to clicks) of users relative to their “click-through rate” (the ratio of clicks to searches) on the listing may be so low as to have a negative ROI for the advertiser. Indeed, a position other than the top position may in fact be more optimal for a particular advertiser if the advertiser is able to achieve a greater volume of actions. However, current systems do not account for this fact, do not provide tools to the advertiser to manage ROI on this basis and are based solely on driving top paying sites to the top positions the search results page.

Another problem inherent in the current PPC system is the lack of a relationship between the placement of the advertiser listings and the quality of the advertiser site. “Quality”, in this case, is defined as the likelihood that the advertiser's site fulfills the needs of users who enter particular search terms that lead to an action. The current system only directly relates the position of the advertiser listing to the willingness of the advertiser to spend money on site traffic. Accordingly, the most relevant site (i.e., the site that will lead to the greatest number of actions) may get minimal representation on the search results page due only to inferior resources to pay for traffic while those sites that are relatively less relevant can drive higher amounts of traffic by simply allocating more monetary resources. In essence, the current iteration of this technology is overly simplistic and concentrated on artificially created results, and not the performance of the advertiser, in that the success of the listing as related to user actions is not a factor in determining relevancy.

Another problem with the current system is that the distribution partners, namely those that generate searches on behalf of the PPC search engine in exchange for monetary compensation, are not rewarded based upon the actual dollars spent by the user they refer. Rather, the distribution partners are paid per click, most often based on a share of the bid revenue derived by the engine. Thus, it is in the interest of the distribution partners to forward as much traffic as possible because all that is required for payment in most implementations is for a user to click on an advertiser's link. In this manner, a distribution partner with a high volume of traffic, but traffic that is not well qualified (i.e., again, less likely to result in an action by a user) might receive more compensation than a second distribution partner with a lower volume of traffic that is highly qualified, that is, more likely to result in an action by a user. The distribution of compensation based solely upon click revenue, regardless of whether the traffic results in actions on the advertisers' sites, fails to provide an incentive for the distribution partner to forward quality traffic and, in fact, creates an opportunity for fraudulent distribution partners to make money by sending artificial traffic and clicks to the search engine, directly decreasing the advertisers' ROI. In fact, this issue of fraud is prevalent among PPC engines and has been a real, and virtually unmanageable, impediment to the growth of this industry.

In summary, the PPC search engine model has been proven to be an effective alternative to previous methods of search engine based marketing on the Web. In fact, this form of advertising has grown to become one of the more widely recognized forms of acquiring qualified leads. From the advertiser's perspective, payment for advertising is made only when a user clicks on the advertiser's listing and is actually transferred to their site However, PPC campaigns are difficult to manage due to the lack of information and control, and further, create an environment in which bid prices are pushed to maximum levels, resulting in potentially negative ROI for the advertiser. From the users' perspective, the advertiser listings displayed are generally targeted to the intent of the query, however, there is no direct relationship between the quality of the listings (i.e., the rate at which similar users find what they need at the advertiser's site) and their rank on the result page, as placement is determined solely by ability to pay. Finally, distribution partners are rewarded for the transfer of their users to advertiser sites but the payment is not related to actual actions taken by users referred by the distribution partner. The effect of this is to reward all distribution partners in the same manner, without regard to the differences in traffic quality among distribution partners.

A need in the industry exists for a search engine that is capable of placing an advertiser's link on a search results list, wherein the placement of each listing in the search results optimizes each advertiser's utilization of advertising dollars and frees the advertiser from management of his or her campaign, including the constant maintenance of bids on particular search terms. Further, a need exists for a search engine system that directs qualified users to advertisers based on a specific “cost-per-action” (“CPA”) specified by the advertiser, wherein CPA refers to a payment made by the advertiser, to a traffic provider, in response to an action. Still further, a need exists for a search engine system that improves the relevancy of the listings by accounting for other factors, such as the number of completed actions, thus improving the user experience Finally, a need exists for a search engine that correlates the compensation paid to distribution partners to the actions of users referred by those partners.

### SUMMARY OF THE DISCLOSURE

The present invention seeks to address the shortcomings set forth above by facilitating the real-time exchange of information among the advertisers, the distribution partners and the search engine, thereby creating a closed market environment in which each component participating in the system is optimized for financial performance. Embodiments of the present invention are directed to a search engine system, method and apparatus that is configured to assess and place an advertiser's link in an optimal position on a search results list, wherein the determination of the ranking on the search results list is based upon a multiplicity of variables. Overall, in preferred embodiments, the search engine system comprises a search engine or processor, a participant management system, a listing database, at least one storage database, and at least one feedback mechanism. Each of these components is coupled together and is in electronic communication with the others.

The search engine is configured to accept input data, such as, search terms, from other network devices, and utilizes the input data to search for information related to the search terms. In preferred embodiments, the search engine reviews information stored in the storage database, as well as, the network system. The search engine comprises a data analysis module that processes and analyzes the incoming data from the other network devices and from the previously stored data. Upon retrieval of relevant information, the data analysis module organizes the data related to the search terms into a search results list, wherein the search results list is presented to the user.

The initial listing information is input into the search engine system via the participant management system and stored in the listing database. Each participating advertiser of the search engine system registers with the system prior to participation and provides a plurality of information, possibly including, listing information, search terms and/or categories relevant to the listing, a description of the listing and a CPA, wherein the CPA is determined by the advertiser as related to the advertiser's ROI.

To determine the placement of listings for a search request, the data analysis module calculates a probability, for each relevant listing, that the user will ultimately complete the desired action if the listing is shown, wherein the probability of action is determined by a plurality of factors. This probability is then combined with the specific CPA for the advertiser. The value of each listing is separately determined for each identified listing and the listings are placed in descending order of this value. As the advertiser listing participates in the search engine system, activity information is tracked for each advertiser. The activity information is processed through the feedback mechanism that provides the data, namely, click-through rates for particular distribution partners, actions and charge-back rates, to the search engine for revised calculations of the listing placement. As new data are obtained, the data analysis module revises the advertiser listing's probability of action estimate.

A feature of preferred embodiments of the invention is the monitoring of the action data, for example, sales data in relation to each distribution partner. An advantage of this feature is that the distribution partners must provide quality traffic in order to receive payment. A further advantage is that the amount of revenue generated by a distribution partner is commensurate with the amount of quality traffic provided to the advertiser, thereby rewarding quality traffic providing distribution partners

A further feature of preferred embodiments is that the result of every transaction of an advertiser is monitored and recorded in association with relevant factors, such as, the distribution partner and search terms. An advantage to this feature is that the factors governing the transactions can be altered to increase the probability of an action, thereby enhancing the probability of the advertiser's success in its marketing efforts.

Another feature of preferred embodiments is that the advertiser predefines a fee to pay per action. An advantage to this feature is that the advertiser is not paying for traffic that does not generate revenue, thereby reducing the risk of spending marketing dollars without a sufficient ROI.

A further feature of preferred embodiments is that the search engine dynamically reassesses the advertiser's listing position in light of newly acquired transaction data. An advantage to this feature is that the advertiser is not required to monitor the success of search engine marketing. A further advantage is that the advertiser's listing position is updated to maintain the most optimal position for the advertiser, thereby increasing the opportunity for an action.

The above and other features and advantages of embodiments of this invention will be apparent from the following more detailed description when taken in conjunction with the accompanying drawings of illustrative embodiments.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 is a schematic of a search engine system in accordance with the preferred embodiment of FIG. 1.

FIG. 3 is a block diagram of operation of the search engine system in accordance with a preferred embodiment of the invention.

### DESCRIPTION OF PREFERRED EMBODIMENTS

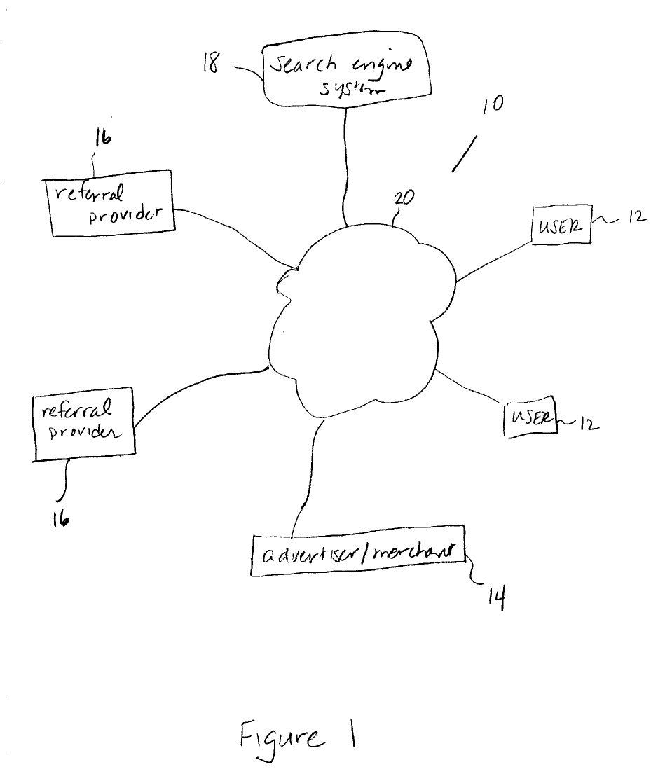

Embodiments of the present invention are directed to a search engine system, method and apparatus that is configured to assess and place an advertiser's link in an optimal position on a search results list, in some instances on a distribution partner-by-distribution partner basis, wherein the determination of the ranking on the search results list is based upon a multiplicity of variables. With reference to FIG. 1, preferred embodiments of the instant invention operate with a network comprising a plurality of networked computers which are coupled together in a communications network, such as, for example, the Internet or the Web. FIG. 1 depicts a simplified representation of an example network system 10 that is operated in accordance with preferred embodiments of the invention.

Hardware Environment:

In the illustrated embodiment, the network system 10 includes at least two client or user computers 12, at least one advertiser computer 14, at least one distribution partner computer 16 and a search engine system 18 coupled for communication there between, generally represented at 20. It will be understood that further embodiments may employ any suitable number of user, advertiser and distribution partner computers, or may eliminate the distribution partner computer, wherein the user directly communicates with the search engine system and the advertiser. The network system 10 may comprise a closed or intranet configuration, an open or public-access network configuration or combinations of such configurations, as is well known in the art. In an Internet embodiment, the network system 10 comprises a combination of a large number of interconnected internets and intranets. For purposes of simplifying the present disclosure, the various hardware components (for example, host servers, routers, connectors, etc.) and software necessary for communication between computers on the network system are not described herein in detail. Such hardware and software are well within the scope of one of ordinary skill in the art and are at least partially dependent upon the type of network system employed and the desired application of use.

The user computer 12 and the advertiser computer 14 may comprise any suitable network device capable of communicating with other network devices in the network system. In preferred embodiments, the user computer 12 and advertiser computer 14 comprise a programmable processor capable of operating in accordance with programs stored on one or more computer readable media (for example, but not limited to floppy disc, hard disc, computer network, random access memory (RAM), CD-ROM, or the like), a display device for providing a user-perceivable display (for example, but not limited to visual displays, such as cathode ray tube (CRT) displays, light-emitting-diode (LED) or liquid-crystal-diode (LCD) displays, plasma displays or the like, audio displays or tactile displays), and a user input device (for example, but not limited to, a keyboard, mouse, microphone, or the like). In one preferred embodiment, the user computer and advertiser computer comprise a personal computer system having a CRT display, a keyboard and a mouse user-input device.

The user computer 12 and advertiser computer 14 are controlled by suitable software, including network communication and browser software to allow a user to request, receive and display information (or content) from or through a distribution partner computer 16 on the network system 10. In preferred embodiments, the user computer 12 and advertiser computer 14 employ a program, such as a browser, for displaying content received from other network devices, such as a distribution partner computer 16, or a search engine system 18.

The distribution partner computer 16 may comprise any suitable network device capable of providing content (data representing text, hypertext, photographs, graphics video and/or audio) for communication over the network. In preferred embodiments, the distribution partner computer 16 comprises a programmable processor capable of operating in accordance with programs stored on one or more computer readable media (for example, but not limited to, floppy disks, hard disks, random access memory RAM, CD-ROM), to provide content for communication to another network device. The distribution partner computer may comprise, for example, but is not limited to, a personal computer, a mainframe computer, network computer, portable computer, personal digital assistant (such as, Palm Inc.'s Palm Pilot), or the like. The distribution partner computer 16 may include one or more internal data storage devices (not shown) or may be coupled to an external data storage device, computer or other means. In addition to communicating with a user computer 12, the distribution partner computer 16 is also in electronic communication with the search engine system 18.

The search engine system 18 may comprise any suitable network device capable of processing information and providing content (data representing text, hypertext, photographs, graphics video and/or audio) for communication over the network. In preferred embodiments, the search engine system 18 may comprise, for example, but is not limited to, a personal computer, a mainframe computer, network computer, portable computer, personal digital assistant (PDA), such as, a Palm Inc.'s i705, or the like. The search engine system 18 is similar to the user computer 12, advertiser computer 14 and distribution partner computer 16, and thus, the descriptions set forth above for these devices 12,14, 16 is fully applicable with regard to the search engine system 18.

General Description of the Preferred Embodiments:

Overall, a user enters search terms into an interface from a distribution partner's computer 16, for example, a Web site, such as Yahoo!. It is to be understood that the user could access the search engine system directly through the search engine's URL. Search requests may be sent directly from a user's computer 12, or upon receipt of the user's inquiry, the distribution partner computer 16 forwards the search terms to the search engine system 18. The search engine system 18 searches its databases, and third party locations, for references related to, or matching the requested search terms. Once the references are located, the search engine system 18 organizes and returns a search results list to the user 12 or the distribution partner computer 16, wherein the distribution partner computer 16 transmits the search results list to the user 12. The search result set is a list of hypertext links to data, such as Web pages, that include information relevant to the submitted search terms. The list is displayed on the user's computer 12, wherein the user can review the listings, and if desired, click on a listing. Upon clicking on the link, the user's request is transmitted to the search engine for tracking and then directed to the advertiser's computer 14 associated with that link.

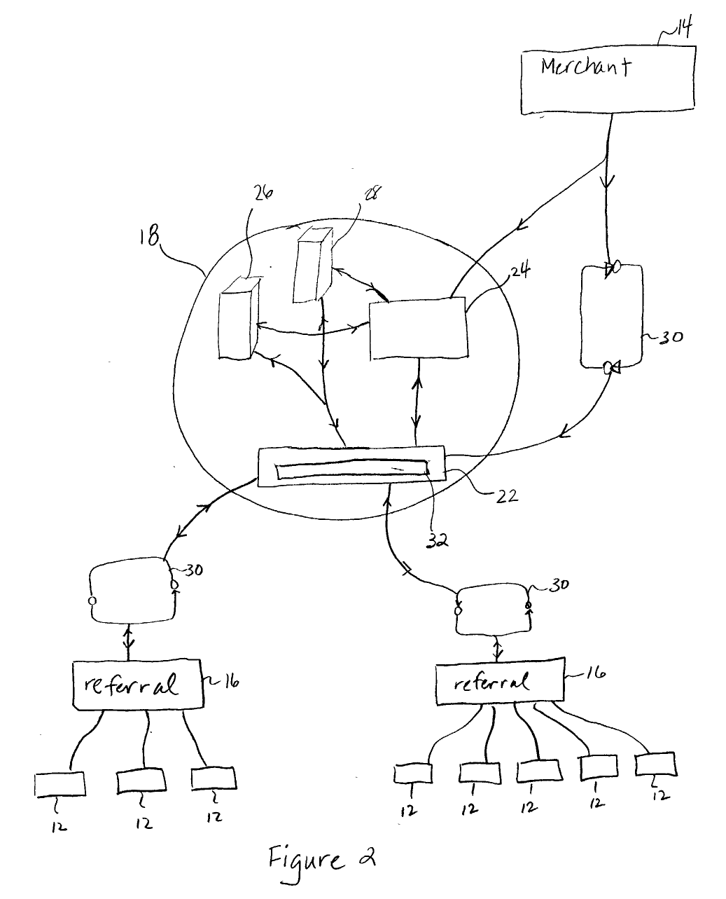

With reference to FIG. 2, in preferred embodiments of the invention, the search engine system comprises a search engine or processor 22, a participant management system 24, a listing database 26, at least one storage database 28 and at least one feedback mechanism 30. Each of these components is coupled together and is in electronic communication with the others

The search engine 22 is configured to accept input data, such as, search terms, from other network devices, including, user computers 12, advertiser computers 14 and distribution partner computers 16. The search engine utilizes the input data to search for information related to the search terms, such as, third party Web pages. In preferred embodiments, the search engine 22 reviews information stored in its databases 26,28, as well as the network system 10.

The search engine 22 comprises a data analysis module 32 that is a software module that processes and analyzes the incoming data from the other network devices and from previously stored data. The data analysis module operates in conjunction with the participant management system, storage database, listing database and the feedback mechanism, and organizes the data related to the search terms into a search results list. The search results list is ultimately presented to the user.

The participant management system receives and manages input data from participants of the search engine system 18. Participants of the search engine system 18 include advertisers and distribution partners. Prior to utilizing or participating in the search engine system 18, the participants must establish an account with the search engine system via the participant management system. Different types of accounts can be established within the participant management system 24. In one preferred embodiment, an advertiser account and a distribution partner account can be established.

To establish an account with the participant management system 24, the participant accesses the participant management system via an interface, such as a Web page, human agent, etc. The interface includes a form with a “Set-up Account” button, or any other interface that may be suitable. Upon activation of the “Set-up Account” button, a set-up page is transmitted to the participant, wherein the participant enters identifying information, including, but not limited to, an account name, a unique identification and a password. The information is entered via input boxes or via response to questions presented by the participant management system 24. Once the participant is satisfied that the input information is accurate, the participant submits the information to the system via a “Submit” button. The submitted information is then validated and written into the storage database 26. In one preferred embodiment, the participant identifies the type of account that the participant desires to establish, namely, an advertiser account or a distribution partner account or both.

Once the participant has established or opened an account, the participant defines account management parameters. To define the account management parameters, in one embodiment, the participant logs into the newly created account and accesses an “Account Management Parameters” page, wherein the participant identifies parameters that will govern the account. The parameters governing the account will depend, in part, upon the type of account.

If the participant is an advertiser, the advertiser accesses an advertiser input page and inputs one or more listings. For each listing, the advertiser specifies a listing category profile, the maximum amount that the advertiser will pay the search engine system 18 for an action (the CPA), a listing title, a listing description, and a listing URL.

The category profile is the means by which the advertiser specifies the interest areas of the user with which the listing should be matched. The advertiser will choose among a variety of these areas to establish target interest areas for the listing. In a preferred embodiment, multiple categories (and/or subcategories) can be selected, wherein each category or subcategory is given a weight value which indicates the relative association or relatedness of the listing to that category or subcategory. The higher the weight of a given category, the higher the probability that users with interests in that area will be presented the listing.

Based upon the input information, historical information of the industry in which the advertiser participates, the text of the listing title and description, and/or content of the target advertiser site, the participant management system 24 adjusts, if necessary, the listing category to better define the target audience. This data may be reviewed and refined by an editor of the participant management system to optimize the advertiser's opportunity to market to its target audience.

The input information entered by the advertiser and generated by the participant management system is stored in the listing database 26. The listing database 26 is any type of storage medium, internal to the search engine system, or separately coupled to the search engine system, or any combination thereof. The listing database 26 is a database containing the identification of the listing, including, but not limited to, the identification of the advertiser, its listing title, URL, listing description, target category profile, and the CPA the advertiser is willing to pay for each action.

The system provides the feedback mechanism 30 for the advertiser to report the actions for which he is willing to pay the CPA amount. This reporting mechanism includes provisions for tracking user information, search term and listing positioning, distribution partner information, and other factors relating to the search transactions that can be used in calculating future listing placements. In a preferred embodiment, multiple feedback options are provided for allowing the advertiser to report payouts to the search engine based on variable payments other than by fixed CPA (e.g. percentage of total sale or per-product commission or bounty). In a preferred embodiment, the advertiser can also elect to pay for every search result that includes the advertiser listing or a visit to a certain page on the advertiser's site.

As the system accepts queries from users, generates search results lists for each query, and processes user clicks, it will record various data regarding these transactions, or activity events, including, but not limited to, the specific listings shown for each query, the position of each listing in each search results list for each query, which, if any, listings were clicked by the user, and which, if any, clicks resulted in actions. These and other transaction data are stored in the storage database 28. These data will be used to adjust the placement of listings shown for future queries.

It is to be understood that the advertiser's listing position can change in real-time as transaction data is obtained. Indeed, as more data is obtained, the data analysis module 32 can more easily ascertain the optimal ordering of the search results list. As will be discussed below, the placement position of the advertiser's listing is not dependent upon any single factor, but rather, is a result of an assessment of a variety of factors which assist in determining the optimal ordering of the search results list.

If the participant is a distribution partner, the participant enters data including the business name, address and tax information (either a Social Security number or Federal Tax ID Number (EIN)) as well as all URLs from which traffic will be originating. In addition, an electronic fee agreement between from the distribution partner and the search engine is established. The distribution partner or the search engine may also assign an initial category profile to each distribution partner URL, wherein the category profile is reflective of the type of user generally utilizing the distribution partner computer. This category profile is of the same form as those described above for advertiser listings and may be used to determine listings and order of listings in search results lists sent to users forwarded from this distribution partner. This profile may also be modified over time by the system or editors based on actual measured performance of listings having various category profiles.

Quality of the traffic is measured, in part, by the action rate, that is, the ratio of the number of actions resulting from traffic forwarded by a particular distribution partner to the number of clicks resulting from the traffic forwarded by the particular distribution partner. Thus, the volume of traffic, number of clicks and the number of actions generated from that traffic is tracked. In this manner, it is not advantageous to merely forward a high volume of traffic; rather, the distribution partner must forward traffic that is highly relevant for the advertiser, wherein the relevancy is reflected in the amount of actions resulting from the forwarded traffic.

To assist in tracking the desired information for use in the search engine system, a unique token is passed to the advertiser with each click on the advertising link by a user and returned to the search engine via a feedback mechanism 30. The feedback mechanism is a software module that allows for the exchange of data between the advertiser computer 14 and the search engine 22. The feedback mechanism 30 assists in monitoring information, including, but not limited to, the number of actions, the amount paid by the advertiser, listing data, and the keywords or categories leading to the action.

The tracking of data from the advertiser computer and the distribution partner computer assists in establishing relevant data for use in optimizing the type of traffic to forward to the advertiser. For example, the feedback mechanism coupled to the distribution partner assists the search engine in determining a more accurate category profile of the distribution partner. Further, the amount and quality of traffic generated by each distribution partner can be measured and qualified. This information, which will be discussed below, assists in determining the type of search results list to generate for a given distribution partner, which, in turn, assists in assessing the type of traffic to forward to the advertiser, that is, determining the optimal position in the search result list for a particular advertiser.

Data received by the search engine 22 via the feedback mechanisms is stored in the storage database 28. As indicated above, the storage database stores account information, advertiser data, distribution partner data, including, but not limited to, identification data, sales data, fee arrangements and marketing data.

The system, via the data analysis module 32, determines the placement of listings in such a way as to optimize the revenue generated for each query. In preferred embodiments, the data analysis module 32 estimates the probability, for each listing, that the user will ultimately complete the desired (payable) action if the listing is shown. The CPA for each listing is known. In addition it is assumed that specific locations on the web page or in the results list have priority in terms of click-through rate. For the purpose of exposition and without loss of generality we will assume that the probability of a click, regardless of the listing, is highest in the top position and decreases monotonically. Listings are assigned to these priority locations based on a function of the probability of action and the CPA.

Priority(listing)=ƒ(probability(action|listing, query, . . . ), CPA)

The probability of action is determined by examining the history of the listing (the temporal pattern of searches for the query (or other similar queries) the listing is assigned to, the temporal pattern of the clicks on the listing, and the temporal pattern of the actions on the advertisers site), and other factors, including, but not limited to, listing category profile, search term category profile, click through rate of the listing, both absolute and relative to the average click through rate of all listings in the positions it has appeared in, charge back rates, prior placement position in the search list for the same or similar search terms, the category profile of the distribution partner site forwarding the user, demographic parameters of the user or distribution partner site, seasonality and/or other dynamic factors.

The function ƒ may be as simple as a straight multiplication of the probability of action and the CPA. However, optimization may require a more complicated function, and as such, in some preferred embodiments, a scaling factor is included in the equation, wherein the probability of action or the CPA is replaced by some scaling function of its value, e.g., an exponential function which either increases or decreases the range of values. The scaling function can be system-wide or situation-specific.

Initially, the probability of action of a new listing is unknown. In these cases, the listing may be judged based on system- or category-wide averages (or other measure of central tendency), or the system may choose some arbitrary probability. Once the advertiser listing participates in the search engine system, the feedback mechanism provides further data, including, but not limited to, click-through rates for particular distribution partners, actions, prior placement position in the search results list, and charge-back rates. As new data are obtained, the data analysis module 32 revises the estimate of the listing's probability of action. If the incoming data for all listings remains relatively consistent, the placement for any particular listing will remain relatively constant. Thus, well-performing and/or well-paying listings are rewarded with more traffic through more optimal placement, at the expense of less well-performing or poorer-paying listings.

One of the variables that may be a determining factor in assessing the listing placement is the identification of the distribution partner site forwarding the user. In preferred embodiments, each distribution partner is tracked separately such that traffic from one distribution partner may affect the placement of the listing position of a given advertiser for a given search term. This is due to the category profile of each advertiser listing as it relates to the category profile of the distribution partner site. Indeed, for each forwarded search request, a review is conducted of the distribution partner site's category profile. This determination assists in knowing the general profile of the distribution partner, and thus, assists in determining which advertiser listings related to the search terms might be appropriate.

In some preferred embodiments, a function of Action Rate (AR), or the ratio of actions to clicks for a given listing, is used to predict the listing's probability of action. In a preferred embodiment, the AR function may use an exponential moving average (EMA) or other function of historical performance of the last few days' or hours' or other periods' actions, clicks, or action rate in a period. EMA for a value n in period t is defined as

EMA(n,t)=n*k+EMA(n,t−1)*(1−k)

where EMA(n,t−1) refers to a prior period calculation for n, and k is a value between 0 and 1 that establishes the rate of decay.

Additionally, a function of Click-Through Rate (CTR), or the ratio of searches to clicks for a given listing can be utilized to determine the probability of action. Utilizing the CTR assumes that the probability of action is higher if the probability of clicking on the listing is higher than the probability of clicking on another if placed in the same position. That is, the relative click through rate (ratio of the listing's CTR to the average CTR in that position) may be used instead of the actual click through rate. Such a function may also be an EMA of the last few days' or hours' or other period's clicks, searches, or click through rate. Thus, in one preferred embodiment,

Priority(listing)=EMA(relative CTR)* EMA(AR)*CPA.

Still, in other preferred embodiments, the data analysis module 32 manipulates the listings shown and their positions in order to optimize the revenue generated by each query by performing a gradient descent algorithm or other multivariate optimization algorithm using dozens of factors, such as listing category profile, search term category profile, click through rate, action rate, charge back rates, the category profile of the distribution partner site forwarding the user, demographic parameters of the user or distribution partner site, seasonality and/or other dynamic factors.

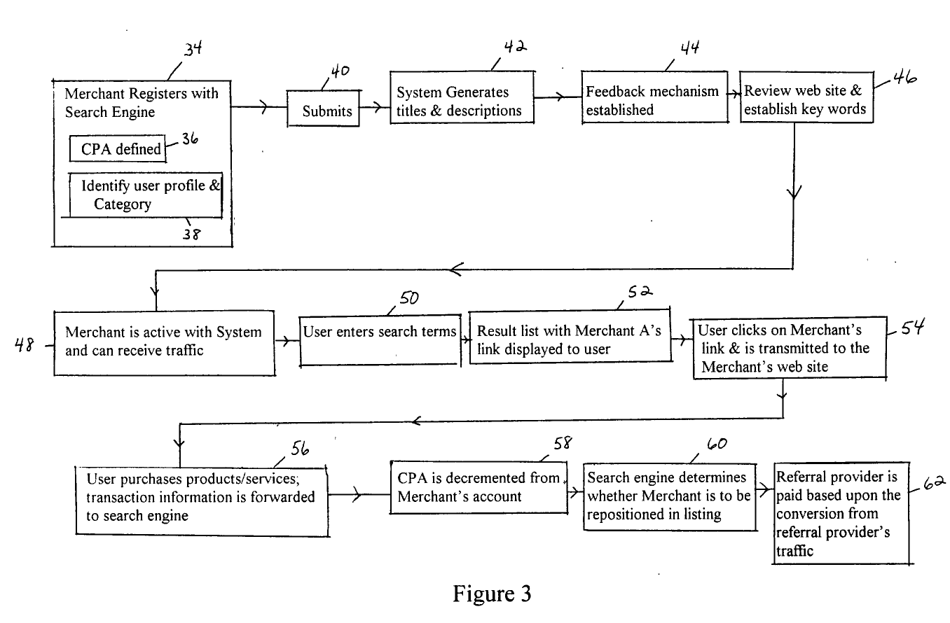

In operation, with reference to FIG. 3, advertiser A registers with the search engine system 34. Upon submission of the registration information, advertiser A is registered with the system and an advertiser account is established. Next, advertiser A enters one or more listings, and indicates for each listing the amount to pay per action, that is, the CPA 36. For example, advertiser A indicates a willingness to pay a fee of $40.00 per action stemming from a particular listing. Thus, for every action made on advertiser A's Web site due to traffic forwarded by the search engine for that listing, advertiser A pays the search engine the agreed upon CPA. In some preferred embodiments, advertiser A has previously deposited funds with the search engine and the monies are automatically deducted. If the funds become low, advertiser A is notified.

Further, during the registration process, advertiser A identifies his category profile 38 for each listing. Once advertiser A indicates the CPA and category profile, advertiser A submits the information to the search engine system 40. Advertiser A also indicates title information for each listing and the description for the listing.

Additionally, code is forwarded to advertiser A for incorporation into advertiser A's Web site, wherein the code establishes the feedback mechanism 44 to allow action data to be returned to the search engine for each action, whether a consummated sale or other action. Data returned to the search engine includes, without limitation, a reference back to the search and click data. In a preferred embodiment, the returned data may include sales amounts associated with the click and other information related to the search transaction. The data is stored in the storage database for future reference. For instance, if it is determined that the same user is requesting a similar search, purchase information is already known about the user for similar search terms. In this manner, the search engine can determine a more effective search results list to present to the user, based upon the past behavior of that specific user. Further, the feedback mechanism allows advertisers to amend previously reported actions in case of returns, charge-backs, and the like, so that transaction information can be updated. Upon completion of the registration and listing entry, advertiser A's listings becomes active and the advertiser can now receive traffic 48.

A user enters search terms on a distribution partner's Web page 50 or the search engine's main portal 18. The user's search request is transmitted to the search engine. In addition to the transmission of the search request, the user's identification with the appended identification of the distribution partner is also transmitted. If the category profile of the user's search terms is associated with one of advertiser A's listings, advertiser A's listing will appear in the search results listings 52 in the optimal position based on the relative ranking of all the related listings. The user clicks on advertiser A's listing, and the user's expanded identification is transmitted to advertiser A's Web site 54. The appending of the distribution partner's identification allows for the tracking, quality determination and association of the traffic.

If the user purchases products or services from advertiser A or takes any other payable action, the transaction information, distribution partner's information and user information, is transmitted to the search engine 56. The search engine decrements the CPA from advertiser A's advertising account 58. Further, the search engine calculates the action rate of advertiser A and if appropriate, repositions advertiser A in the listing 60 on a distribution partner-by-distribution partner basis. Finally, the search engine calculates the payout to the distribution partner based upon the action resulting from the particular distribution partner's traffic 62. In this manner, the distribution partner is paid in accordance with the successful results of its traffic.

Although the foregoing described the invention with preferred embodiments, this is not intended to limit the invention. Rather, the foregoing is intended to cover all modifications and alternative constructions falling within the spirit and scope of the disclosure and the embodiments as described. For instance, in still other preferred embodiments, the predefined CPA can be a sliding amount, wherein the advertiser never pays above a predefined maximum amount. Further still, to minimize the cost and risk to the search engine providing the traffic to the advertiser, in some preferred embodiments, the CPA is used to pay both for visits to certain pages and for sales. In this embodiment, the advertiser pays a predefined minimal amount for every page visit up to the maximum agreed CPA. The minimal amount is preset by the search engine, and thus, no bidding is occurring. In this embodiment, if a sale occurs prior to the exhaustion of the CPA, the advertiser only pays the difference between the maximum CPA and the amounts previously paid for the set of visits. If no sale occurs, the advertiser pays per visit up to the predefined CPA Once the CPA maximum has been reached with no sales, the CPA balance is reset to the full CPA. In this manner, the search engine benefits as it receives some compensation for its costs, such as, bandwidth, and simultaneously, the advertiser benefits as the advertiser can monitor its costs in increments of CPA charges and does not incur fees over the agreed upon CPA for any given sale.

What is claimed is:

1. A search engine system on a computer network having a search engine provider computer, a merchant computer, and a user computer, wherein the provider computer, the merchant computer and the user computer are in communication therebetween, the search engine system being configured to generate a search result set in response to a search request from the user computer, the search engine system comprising:
a search engine configured to receive the search request;
a participant management system configured to receive a listing from the merchant computer, wherein the listing includes a category profile, payment amount for an action resulting from user response, a title, a description and a data locator;
a database; and
a feedback mechanism, wherein the feedback mechanism couples the merchant computer and the search engine such that data is transferred between the merchant computer and the search engine.

2. A search engine system as claimed in claim 1, wherein the search engine further comprises a data analysis module, the data analysis module operating in conjunction with the participant management system, the database and the feedback mechanism, wherein the data analysis module is configured to analyze data input into the search engine system and data previously stored in the database to determine a search result list of listings and the placement of the listing within the search result list, wherein each listing has a probability of action.

3. A search engine system as claimed in claim 1, wherein the data analysis module is configured to determine the placement of the listings by calculating the probability of action for each listing, wherein the probability of action includes a plurality of factors.

4. A search engine system as claimed in claim 2, wherein the data analysis module is configured to determine the placement of the listings by combining the probability of action with the payment amount for the listing.

5. A search engine system as claimed in claim 1, wherein the feedback mechanism further comprises a tracking means for recording transaction data, wherein the search engine utilizes the recorded transaction data to revise the probability of action for a listing.

6. A search engine system as claimed in claim 1, wherein the recorded transaction data consists of any of the following: user information, search term in search query, listing position, and listings included in the search request.

7. A search engine system as claimed in claim 1, further comprising a distribution partner computer, the distribution partner computer being coupled to the network and being configured to receive a search request from the user computer, wherein the distribution partner computer inputs distribution information in the participant management system, including a distribution partner category profile, the distribution partner category profile being related to the type of user utilizing the distribution partner computer.

8. A search engine system as claimed in claim 6, wherein the distribution partner computer is configured to transmit a user or a user search request to the search engine, wherein the search engine utilizes the distribution partner category profile to calculate the listing placements for the search request.

9. A search engine system as claimed in claim 6, wherein the distribution partner further comprises a traffic quality rating, wherein the traffic quality rating is determined by calculating an action rate, the action rate being defined as ratio of the number of actions resulting from traffic forwarded by the particular distribution partner to the number of clicks resulting from the traffic forwarded by the particular distribution partner.

10. A search engine systems as claimed in claim 7, wherein the traffic quality rating is determined by calculating a revenue amount per search, the revenue amount per search defined as the ratio of the revenue received as a result of all user searches distributed through the distribution partner to the search engine divided by this number of searches.

11. A search engine system as claimed in claim 2, wherein the plurality of factors consists of any of the following: history of the listing, listing category profile, search term category profile, relative or absolute click through rate, action rate, charge back rates, prior placement position in the search list for the search term or similar search terms, the distribution partner category profile of the distribution partner transmitting the user, demographic parameters of the user, demographic parameters of distribution partner site, and temporal data.

12. A method for generating a search result listing on a computer network having a provider computer, a merchant computer, and a user computer, wherein the provider computer, the merchant computer and the user computer are in communication therebetween, the method comprising:
establishing a participant account on a search engine system via the provider computer, wherein the participant account includes at least one listing, wherein the listing includes a category profile, payment amount for a completed action, a title, a description and a data locator;
generating an initial placement position in a search result list for each listing in the participant account;
receiving a search request on the provider computer from the user computer, wherein the search request includes at least one search term;
generating a search result list of listings associated with the search request, wherein the listings are ordered in accordance with a placement position determination, the determination of the placement position of each listing being determined by a plurality of factors,
presenting the search result list to the user computer; and
recording transaction data for each search request.

13. A method as claimed in claim 12, wherein the listing includes a search term and wherein listings are associated with user search requests via matching the search term specified with the listing and the search term included in the search request.

14. A method as claimed in claim 12, wherein listings are associated with user search requests via matching the listing category profile and the user search term category profile.

15. A method as claimed in claim 12, further comprising revising the placement position determination for the stored listings associated with the search terms in the search request.

16. A method as claimed in claim 12, wherein the recorded transaction data consists of any of the following: search terms composing the search request; placement position of each listing in the search result list for each request; listings clicked on by user; and actions resulting from each listing click.

17. A method as claimed in claim 12, wherein revising the placement position comprises calculating the probability of action, wherein the probability of action is determined utilizing a plurality of factors.

18. A method as claimed in claim 12, wherein the plurality of factors consists of any of the following: history of the listing, listing category profile, search term category profile, absolute or relative click through rate, action rate, charge back rates, prior placement position in the search list for the search term or similar search terms, the distribution partner category profile of the distribution partner site transmitting the user, demographic parameters of the user, demographic parameters of distribution partner site, and temporal data.

19. A method as claimed in claim 12, further comprising:
establishing a distribution partner account for a distribution partner computer, wherein the distribution partner computer is coupled to the network, and wherein the distribution partner is configured to transmit user search requests to the provider computer; and
assigning a category profile to the distribution partner.

20. A method as claimed in claim 19, further comprising:
transmitting a user or the user search request to the provider computer from the distribution partner computer; and
wherein the plurality of factors for the determination of the placement position for each listing includes the category profile assigned to the distribution partner.

21. A method as claimed in claim 12, further comprising recording transaction data via a feedback mechanism.

22. A method as claimed in claim 19, further comprising determining the quality of the traffic transmitted by the distribution partner.

23. A method as claimed in claim 22, wherein the quality of the traffic is related to the number of actions generated from previously transmitted traffic by the distribution partner.

24. A method as claimed in claim 22, wherein the quality of the traffic is related to the revenue generated from previously transmitted traffic by the distribution partner.

25. A method as claimed in claim 22, wherein the quality of the traffic is related to the revenue generated per search from previously transmitted traffic by the distribution partner

26. A method as claimed in claim 12, further comprising editing, by the provider computer, the listing data information input by the merchant computer.

27. A method for generating a search result listing on a computer network having a provider computer, a merchant computer, a plurality of distribution partner computers, and a user computer, wherein the provider computer, the merchant computer and the user computer are in communication therebetween, the method comprising:
establishing a participant account on a search engine system via the provider computer, wherein the participant account includes at least one listing, wherein the listing includes a category profile, payment amount for a completed action, a title, a description and a data locator;
establishing a first distribution partner account on the search engine system via the provider computer, wherein the distribution partner computer is assigned a first participant profile;
establishing a second distribution partner account on the search engine system via the provider computer, wherein the distribution partner computer is assigned a second participant profile;
receiving a search request on the provider computer, wherein the search request includes at least one search term;
generating a search result list of listings associated with the search request, wherein the listings are ordered in accordance with a placement position determination, the determination of the placement position of each listing being determined by a plurality of factors,
presenting the search result list to the user computer; and
recording transaction data for each search request.

28. A method for generating a search request as claimed in claim 27, wherein the search request is transmitted by the first distribution partner computer, and wherein the factors in the determination of the placement position of each listing in the search result list include the first distribution profile and the category profile.

29. A method for generating a search request as claimed in claim 27, wherein the search request is transmitted by the second distribution partner computer, and wherein the factors in the determination of the placement position of each listing in the search result list include the second distribution profile and the category profile.

30. A method for generating a search request as claimed in claim 27, wherein the factors in the determination of the placement position of a first listing in a search result list for a search request transmitted by the first distribution partner computer include the first distribution profile and the category profile, and wherein the first listing is assigned a first position placement in the search result; and
wherein the factors in the determination of the placement position of a first listing in a search result list for a search request transmitted by the second distribution partner computer include the second distribution profile and the category profile, and wherein the first listing is assigned a second position placement in the search result.

31. A method for generating a search request as claimed in claim 30, wherein the first position is equivalent to the second position.

32 A method for generating a search request as claimed in claim 30, wherein the first position is different from the second position.
